(19) United States
(12) Patent Application Publication
(10) Pub. No.: US 2015/0172363 A1
(43) Pub. Date: Jun. 18, 2015

(54) ELECTRONIC FILE PROCESSING APPARATUS

(71) Applicant: Xacti Corporation, Daito-shi, Osaka-fu (JP)

(72) Inventors: Hidefumi Okada, Daito-shi (JP); Haruhiko Murata, Daito-shi (JP); Akiomi Kunisa, Daito-shi (JP)

(73) Assignee: XACTI CORPORATION, Daito-shi, Osaka-fu (JP)

(21) Appl. No.: 14/407,181

(22) PCT Filed: Aug. 26, 2013
(86) PCT No.: PCT/JP2013/072644

§ 371 Date: Dec. 11, 2014

(30) Foreign Application Priority Data
Sep. 4, 2012 (JP) 2012-194361

(51) Int. Cl. H04L 29/08; H04B 5/00; G06F 1/26; H04N 5/232

(52) U.S. Cl. CPC H04L 67/06; H04N 5/23293; H04N 5/23241; H04B 5/0031; G06F 1/26

(57) ABSTRACT

A CPU 46p arranged in an RF module 46 detects an ID of an other device transmitted by a Bluetooth communication in a state where a main-power-source switch SW48 is turned of and when the detected ID of the other device is already registered in a registering means 50, the main-power-source switch SW48 is turned on. A camera CPU 22 activated thereby detects a file transfer request transmitted by a WiFi communication so as to transfer an image file stored in a recording medium to a request source in response to the detected file transfer request.

### TECHNICAL FIELD

The present invention relates to an electronic file processing apparatus. More specifically, the present invention relates to an electronic file processing apparatus which transfer an electronic file to a request source upon receiving a file transfer request.

### BACKGROUND ART

One example of this type of a camera is disclosed in a patent literature 1. According to the background art, an NFC transmitting-receiving part arranged in each of a transmission terminal and an information providing device automatically establishes an NFC communication upon entering within a communication range, and exchanges authentication information and connection setting information. Thereafter, when the authentication information is received in the transmission terminal, Bluetooth (Registered Trademark) transmitting-receiving part arranged in each of the transmission terminal and the information providing device establishes Bluetooth communication by using the previously exchanged connection setting information.

By the NFC communication that is easy to send and receive data, the connection setting information necessary for the Bluetooth communication is exchanged between the transmission terminal and the information providing device. That is, only by bringing the information providing device to be close to the transmission terminal, a user of the information providing device is able to exchange information necessary for establishing the Bluetooth communication of the both device. Thereby, without performing a special operation, the transmission terminal to be a communication partner is specified, and the Bluetooth communication becomes possible, and therefore, it becomes possible to improve the convenience.

### CITATION LIST

### Patent Literature

Patent Literature 1: Japanese Patent Application Laid-open Number 2012-85269

### SUMMARY OF INVENTION

### Technical Problem

However, in the background art, it is assumed that both of the transmission terminal and the information providing device are in a powered-on state, and therefore, the convenience is limited.

### Solution to Problem

An electronic file processing apparatus according to this invention comprises: a first detecting means which detects, in a main-power-source off state, identification information transmitted by a first communication system; an activating means which turns on a main power source when a predetermined condition on the identification information detected by the first detecting means is satisfied; a second detecting means which detects, in a main-power-source on state, a file transfer request transmitted by a second communication system; and a transferring means which transfers an electronic file stored in a recording medium to a request source in response to the file transfer request detected by the second detecting means.

Preferably, further comprised is a registering means which registers desired identification information in the main-power-source on state, and the predetermined condition includes a condition under which the identification information detected by the first detecting means is equivalent to the identification information registered by the registering means.

Preferably, each of the first detecting means and the activating means executes a process under a back-up power source.

Preferably, further comprised is an imaging means which outputs image data corresponding to an optical image captured on an imaging surface, and the electronic file is equivalent to a file containing the image data outputted from the imaging means.

Preferably, the first communication system and the second communication system respectively corresponds to two standards out of a WiFi standard, a Bluetooth standard, an NFC standard, a ZigBee standard, an RFID standard and a WirelessHD standard.

A file transfer program according to this invention is a file transfer program recorded on a non-transitory recording medium in order to control an electronic file processing apparatus, the program causing a processor of the electronic file processing apparatus to perform the steps comprises: a first detecting step of detecting, in a main-power-source off state, identification information transmitted by a first communication system; an activating step of turning on a main power source when a predetermined condition on the identification information detected by the first detecting step is satisfied; a second detecting step of detecting, in a main-power-source on state, a file transfer request transmitted by a second communication system; and a transferring step of transferring an electronic file stored in a recording medium to a request source in response to the file transfer request detected by the second detecting step.

A file transfer control method according to this invention is a file transfer control method executed by an electronic file processing apparatus, comprises: a first detecting step of detecting, in a main-power-source off state, identification information transmitted by a first communication system; an activating step of turning on a main power source when a predetermined condition on the identification information detected by the first detecting step is satisfied; a second detecting step of detecting, in a main-power-source on state, a file transfer request transmitted by a second communication system; and a transferring step of transferring an electronic file stored in a recording medium to a request source in response to the file transfer request detected by the second detecting step.

The above described objects and other objects, features and advantages of the present invention will become more apparent from the following detailed description when taken in conjunction with the accompanying drawings.

### BRIEF DESCRIPTION OF DRAWINGS

FIG. 1 is a block diagram showing a basic configuration of one embodiment of the present invention.

FIG. 2 is a block diagram showing one example of a configuration of a digital camera applied to this embodiment.

FIG. 3 is a block diagram showing one example of a configuration of a smartphone applied to this embodiment

FIG. 4 is an illustrative view showing one example of communication behavior between the digital camera and the smartphone.

FIG. 5 is a flowchart showing one portion of behavior of an RF module applied to the embodiment in FIG. 2.

FIG. 6 is a flowchart showing one portion of behavior of a camera. CPU applied to the embodiment in FIG. 2.

FIG. 7 is a flowchart showing another portion of behavior of the camera. CPU applied to the embodiment in FIG. 2.

FIG. 8 is a flowchart showing still another portion of behavior of the camera. CPU applied to the embodiment in FIG. 2.

FIG. 9 is a flowchart showing yet another portion of behavior of a smartphone CPU applied to the embodiment in FIG. 3.

FIG. 10 is a flowchart showing another portion of behavior of the smartphone CPU applied to the embodiment in FIG. 3.

### DESCRIPTION OF EMBODIMENTS

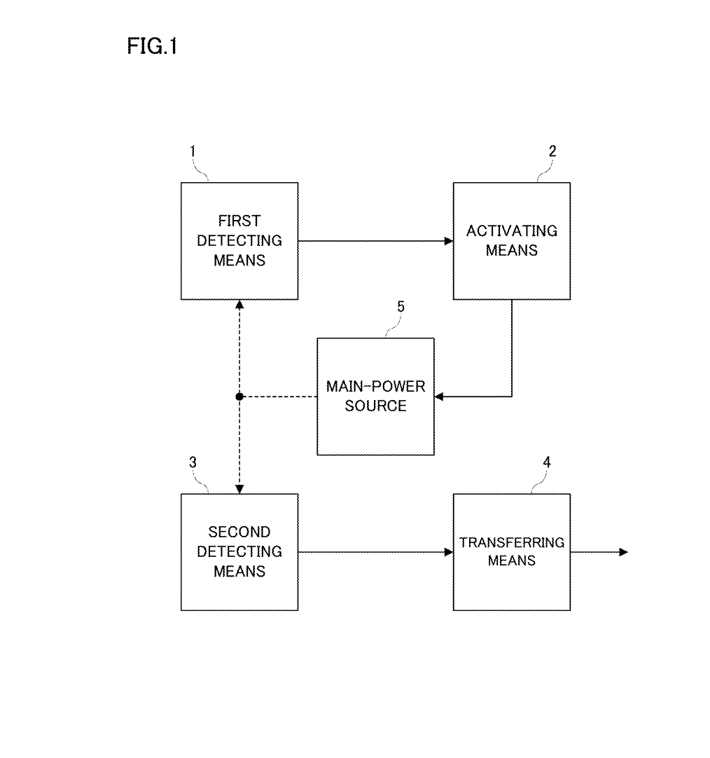

With reference to FIG. 1, an electronic file processing apparatus according to this embodiment is basically configured as follows: A first detecting means 1 detects, in a main-power-source on state, identification information transmitted by a first communication system. An activating means 2 turns on a main power source 5 when a predetermined condition on the identification information detected by the first detecting means 1 is satisfied. A second detecting means 3 detects, in the main-power-source on state, a file transfer request transmitted by a second communication system. A transferring means 4 transfers an electronic file stored in a recording medium to a request source in response to the file transfer request detected by the second detecting means 3.

When identification information satisfying the predetermined condition transmitted by the first communication system is detected, the main power source is changed from an off-state to an on-state. The electronic file stored in the recording medium is transferred to the request source in response to the file transfer request transmitted by the second communication system in this state. Thereby, the convenience is improved such that a battery life is extended, for example.

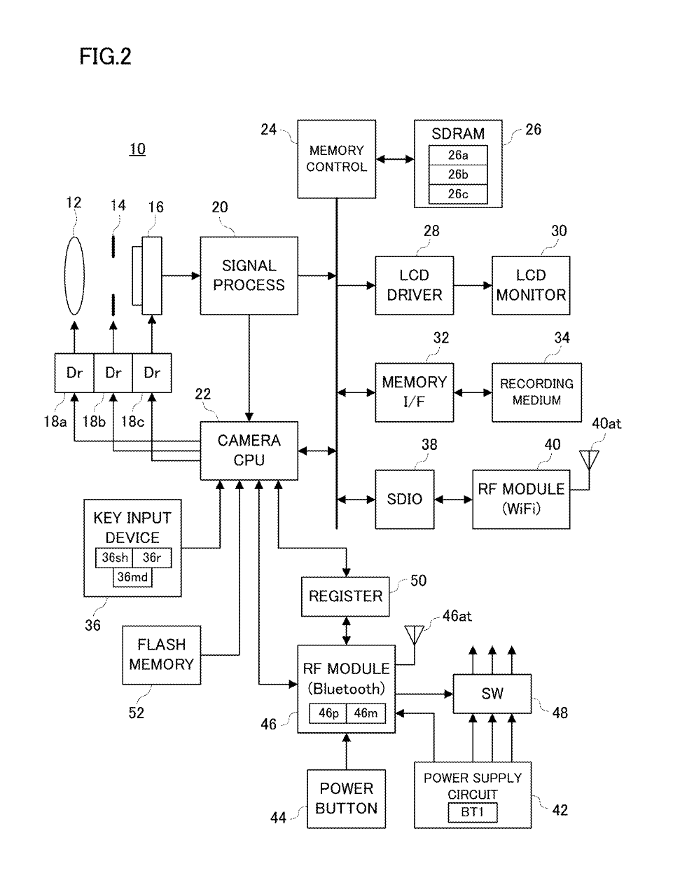

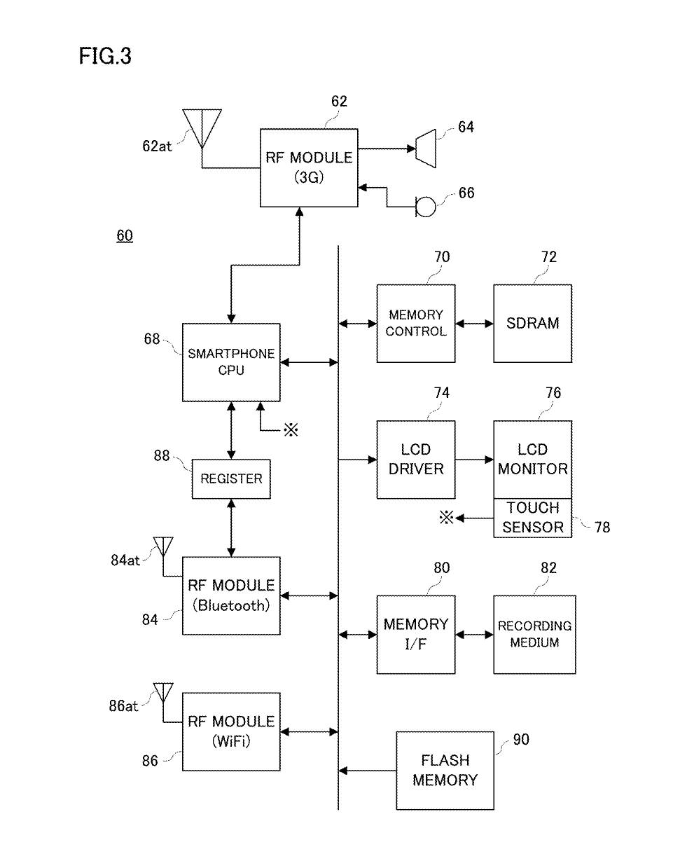

A camera system of this embodiment is formed by a digital camera 10 configured as shown in FIG. 2 and one or at least two smartphones 60 each of which is configured as shown in FIG. 3. Both of the digital camera 10 and the smartphone 60 have a near field communication function according to a Bluetooth standard, and a near field communication function according to a WiFi standard. Bluetooth communication is executed by an RF module 46 shown in FIG. 2 and an RF module 84 shown in FIG. 3. Moreover, WiFi communication is executed by an RF module 40 shown in FIG. 2 and an RF module 86 shown in FIG. 3.

The digital camera 10 is carried by a user to photograph a desired scene while traveling. In contrary, the smartphone 60 is carried by the user for a telephone call or data communication. As a result of such difference in characteristics, a power source of the smartphone 60 is always turned on, whereas a power source (a main power source) of the digital camera 10 is turned on by limiting to a time of photographing or near field communication.

With reference to FIG. 2, the digital camera 10 includes a focus lens 12, an aperture unit 14 and an image sensor 16 respectively driven by drivers 18a, 18b and 18c. An optical image representing a scene enters, with irradiation, an imaging surface of an image sensor 16 via the focus lens 12 and the aperture unit 14.

Moreover, the digital camera 10 includes a power supply circuit 42 containing a battery BT1. The power supply circuit 42 generates a plurality of direct current voltages, each of which shows a voltage value different from each other. One portion of the plurality of generated direct current voltages is directly applied to the RF module 46, and another portion of the plurality of generated direct current voltages is applied to a camera system (except the RF module 46) via a main-power switch 48.

The RF module 46 turned on by the direct current voltage from the power supply circuit 42 turns on the main-power switch 48, in response to a power-on operation by a power button 44, or receiving an ID of an other device registered by the RF module 46. Moreover, the RF module 46 notifies a camera CPU 22 that the main-power switch 48 is turned on resulting from which of the power-on operation or reception of the registered ID of the other device.

It is noted that, the main-power switch 48 thus turned on is turned off by the Bluetooth module 46 when a power-off operation is performed by the power button 44 or when a power-off instruction is issued from the camera CPU 22 (the power-off instruction is issued when a period during which a user operation to a key input device 36 is not performed reaches a reference value).

The camera CPU 22 executes, under a control of the multi task operating system, a plurality of tasks including an imaging task a Bluetooth setting control task and a WiFi communication control task described below, in a parallel manner. However, when receiving the registered ID of the other device causes the power-on operation of the main-power switch 48, the imaging task is excluded from an execution target.

It is noted that control programs corresponding to these tasks are stored in a flash memory 52. Moreover, the WiFi communication control task is activated on the condition that a WiFi connection with the smartphone 60 that is a communication partner is established. Furthermore, an explanation about a process of establishing the WiFi connection is omitted here.

Under the imaging task, in order to execute a moving-image taking process, the camera CPU 22 commands the driver 18c to repeat an exposure procedure and an electric-charge reading-out procedure. At every time a vertical synchronization signal Vsync is generated, the driver 18c exposes the imaging surface and reads out the electric charges produced thereby in a raster scanning manner. As a result, raw image data that is based on the read-out electric charges is repeatedly outputted from the image sensor 16. A signal processing circuit 20 performs a color separation process, a white balance adjusting process and a YUV converting process, on the raw image data outputted from the image sensor 16, so as to write YUV formatted image data created thereby into a moving-image area 26a of an the SDRAM 26 through a memory control circuit 24.

An LCD driver 28 repeatedly reads out the image data stored in the moving-image area 26a through the memory control circuit 24, and drives an LCD monitor 30 based on the read-out image data. As a result, a real-time moving image (a live view image) representing the scene captured on the imaging surface is displayed on a monitor screen.

Y data created by the signal processing circuit 20 is also applied to the camera CPU 22. When a shutter button 36sh arranged in the key input device 36 is in a non-operated state, the camera CPU 22 executes a simple AE process based on the Y data applied from the signal processing circuit 20 so as to calculate an appropriate EV value. An aperture amount and an exposure time period that define the calculated appropriate EV value are respectively set to the drivers 18b and 18c, and thereby, a brightness of the live view image is roughly adjusted.

When the shutter button 36sh is half-depressed by the user, the camera CPU 22 executes a strict AE process based on the Y data applied from the signal processing circuit 20 so as to calculate an optimal EV value. Also an aperture amount and an exposure time period that define the calculated optimal EV value are respectively set to the drivers 18b and 18c, and thereby, the brightness of the live view image is strictly adjusted. Moreover, the camera CPU 22 executes an AF process based on a high-frequency component of the Y data applied from the signal processing circuit 20. The focus lens 12 is placed on a focal point discovered by the AF process, and thereby, a sharpness of the live view image is improved.

When the shutter button 36sh is fully depressed, the camera CPU 22 executes a still-image taking process, and concurrently, commands a memory I/F 32 to execute a recording process. One frame of image data representing a scene at a time point at which the shutter button 36sh is operated is evacuated from the moving-image area 26a to a still image area 26b by the still-image taking process. The memory I/F 32 commanded to execute the recording process reads out the image data thus evacuated through the memory control circuit 24 so as to record the read-out image data on a recording medium 34 in a file format

Under the Bluetooth setting control task, the camera CPU 22 commands the RF module 46 to transmit an ID of own device, under the condition that a Bluetooth communication function is subjected to be an on-state by a mode key 36md arranged in the key input device 36. The RF module 46 repeatedly transmits the ID of own device from an antenna 46at.

When an unregistered ID of an other device is received by the RF module 46, the camera CPU 22 prompts the user to register the ID by using the LCD monitor 30. The ID of the other device is registered on a registering means 50 by the camera CPU 22 when a registration operation is performed by a registration button 36r arranged in the key input device 36. A Bluetooth connection with a transmission source of the ID of the other device is established after the registration is completed. It is noted that, when the registered ID of the other device is received, the Bluetooth connection is quickly established.

When the Bluetooth communication function is switched from the on-state to the off-state by the operation of the mode key 36md, the camera CPU 22 cancels the Bluetooth connection. The above-described process is executed again when the Bluetooth communication function is switched from the off-state to the on-state.

Under the WiFi communication control task, the camera CPU 22 waits for a file transfer request from a device of which the user authentication for the WiFi communication is completed. When the file transfer request is received by the RF module 40, the camera CPU 22 acquires an image file from the recording medium 34. The acquired image file is stored in a work area 26c of the SDRAM 26. Subsequently, the camera CPU 22 commands the RF module 40 to transfer the acquired image file to a request source. The RF module 40 reads out a desired image file from the work area 26c through an SDIO (SecureDigital Input/Output) 38 and the memory control circuit 24, so as to transmit the read-out image file to an issue source of the file transfer request through an antenna 40at.

With reference to FIG. 3, the smartphone 60 includes an antenna 62at and an RF module 62 for a mobile communication. When transmission/reception data is call voice data, a received voice is outputted from a speaker 64, and a transmitted voice is taken by a microphone 66. Moreover, when the transmission/reception data is an image file, the data is processed under a control of a smartphone CPU 68. It is noted that the image file is also received by the RF module 86.

A target image file is written into an SDRAM 72 through a memory control circuit 70. An LCD driver 74 reads out the image data contained in the target image file through the memory control circuit 72, and drives an LCD monitor 76 based on the read-out image data. As a result, a corresponding image is displayed on a monitor screen.

A touch operation to the monitor screen is sensed by a touch sensor 78. A sensed result is applied to the smartphone CPU 68 so as to execute a process different depending on a manner of the touch operation, under the control of the smartphone CPU 68.

The smartphone CPU 68 also executes, under a control of the multi task operating system, a plurality of tasks including the Bluetooth setting control task and the WiFi communication control task, in a parallel manner. Moreover, the control programs corresponding to these tasks are stored in a flash memory 90. Furthermore, where the WiFi communication control task is activated under the condition that a WiFi connection with the digital camera 10 that is a communication partner is established, an explanation about a process of establishing the WiFi connection is omitted here.

Under the Bluetooth setting control task, the smartphone CPU 68 commands the RF module 84 to transmit an ID of own device, under a condition that a Bluetooth communication function is in the on-state. The RF module 84 transmits the ID of own device from an antenna 84at.

When an unregistered ID of an other device is received by the RF module 84, the smartphone CPU 68 prompts the user to register the ID by using the LCD monitor 76. The ID of the other device is registered on a registering means 88 by the smartphone CPU 68 when a registration operation is performed by a touch on the monitor screen. A Bluetooth connection with a transmission source of the ID of the other device is established after the registration is completed. It is noted that, when the registered ID of the other device is received, the Bluetooth connection is quickly established.

When the Bluetooth communication function is switched from the on-state to the off-state by the touch operation to the monitor screen, the smartphone CPU 68 cancels the Bluetooth connection. The above-described process is executed again when the Bluetooth communication function is switched from the off-state to the on-state by the touch operation.

Under the WiFi communication control task, the smartphone CPU 68 commands the RF module 86 to issue a file transfer request, in response to a file-reproducing operation by the touch on the monitor screen in a state where the WiFi communication is established. The file transfer request is transmitted to the digital camera 10 that is a destination of the WiFi communication through an antenna 86at.

When an image file sent back from the digital camera 10 is received by the RF module 86, the smartphone CPU 68 writes the received image file into the SDRAM 72, and commands the LCD driver 74 to reproduce image data. The LCD driver 74 reads out the image data of the received image file through the memory control circuit 70, and drives the LCD monitor 76 based on the read-out image data. As a result, an image photographed by the digital camera 10 is displayed on the monitor screen.

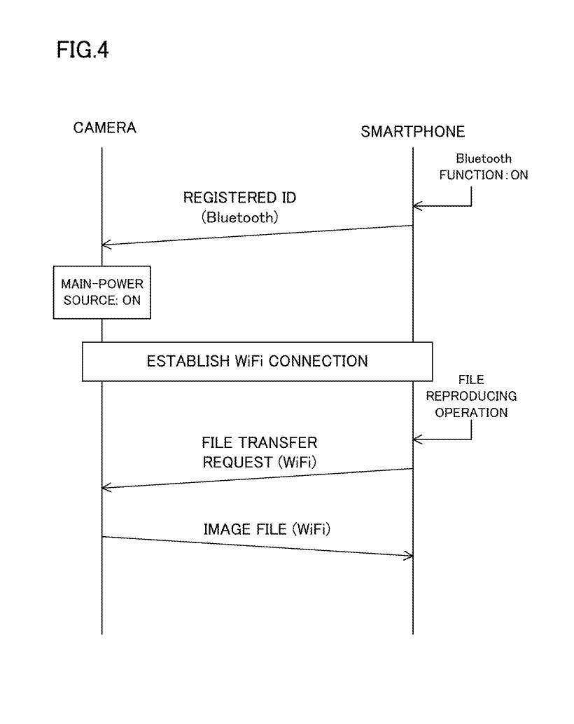

FIG. 4 shows operations as follows: The main-power switch 48 of the digital camera 10 is transitioned from the off-state to the on-state, in response to the registered ID transmitted from the smartphone 60. The image file stored in the recording medium 34 is transferred to the smartphone 60 in response to a file transfer request transmitted from the smartphone 60.

When the Bluetooth function of the smartphone 60 is turned on in a state where an automatic connection to the digital camera 10 is set to the smartphone 60, an ID allocated to the smartphone 60 is transmitted to the digital camera 10 by the Bluetooth communication. When the ID is already registered, the main-power switch 48 of the digital camera 10 is turned on, and thereby, the camera system is activated. Subsequently, the WiFi connection is established between the digital camera 10 and the smartphone 60.

After the WiFi connection is established, when the file-reproducing operation is performed on the smartphone 60 side, a file transfer request is transmitted from the smartphone 60 to the digital camera 10 by the WiFi communication. The digital camera 10 acquires the image file stored in the recording medium 34 so as to transmit the acquired image file to the smartphone 60 by the WiFi communication.

In a state where a bag containing the digital camera 10 of which a main power source is turned off is placed on a loading platform of a train while traveling, when the Bluetooth function of the smartphone 60 in user's hand is turned on, the main power source of the digital camera 10 is activated in a manner described above so as to establish the WiFi connection between the digital camera 10 and the smartphone 60. When the user performs the file reproducing operation toward the smartphone 60, an image file stored in the digital camera 10 is transferred to the smartphone 60 so as to display the image stored in the image file on the monitor screen. Thereby, an operability related to acquiring the image file stored in the digital camera 10 is improved.

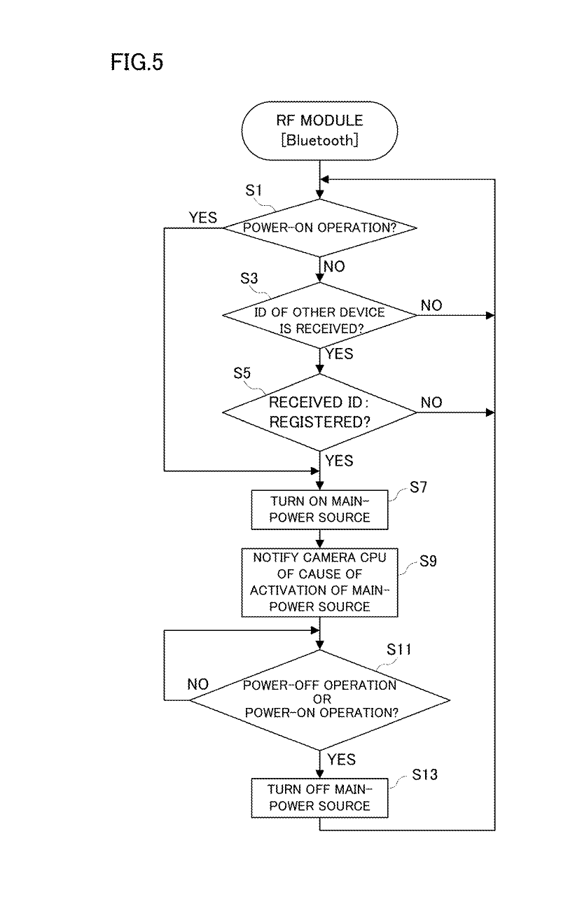

In the digital camera 10, an CPU 46p arranged in the Bluetooth module 46 executes processes according to a flowchart shown in FIG. 5. It is noted that a control program corresponding to the flowchart is stored in a flash memory 46m.

In a step S1, it is determined whether or not the power-on operation by the power button 44 is performed. In a step S3, it is determined whether or not an ID of an other device is received by the antenna 46at. In a step S5, it is determined whether or not the received ID of the other device is already registered in the registering means 50.

When a determined result of the step S1 is NO, and when any one of determined results of the step S3 and the step S5 is NO, the process returns to the step S1. When the determined result of the step S1 is YES, or when both of the determined results of the step S3 and the step S5 are YES, the main-power switch 48 is turned on in a step S7. As a result of a process in the step S7, the camera system is activated.

In a step S9, a cause that the main-power switch 48 is turned on, i.e., a cause of activation of the camera system is notified to the camera CPU 22.

When the power-on operation causes the activation of the camera system, the camera CPU 22 activates a plurality of tasks including the imaging task, the Bluetooth setting control task and the WiFi communication control task, whereas when receiving the registered ID of an other device causes the activation of the camera system, a plurality of tasks other than the imaging task are activated.

In a step S11, it is repeatedly determined whether or not an OR condition under which the power-off operation is performed by the power button 44, or the power-off instruction is issued from the camera CPU 22 is satisfied. When a determined result is updated from NO to YES, in a step S13, the main-power switch 48 is turned off, and thereafter, the process returns to the step S1.

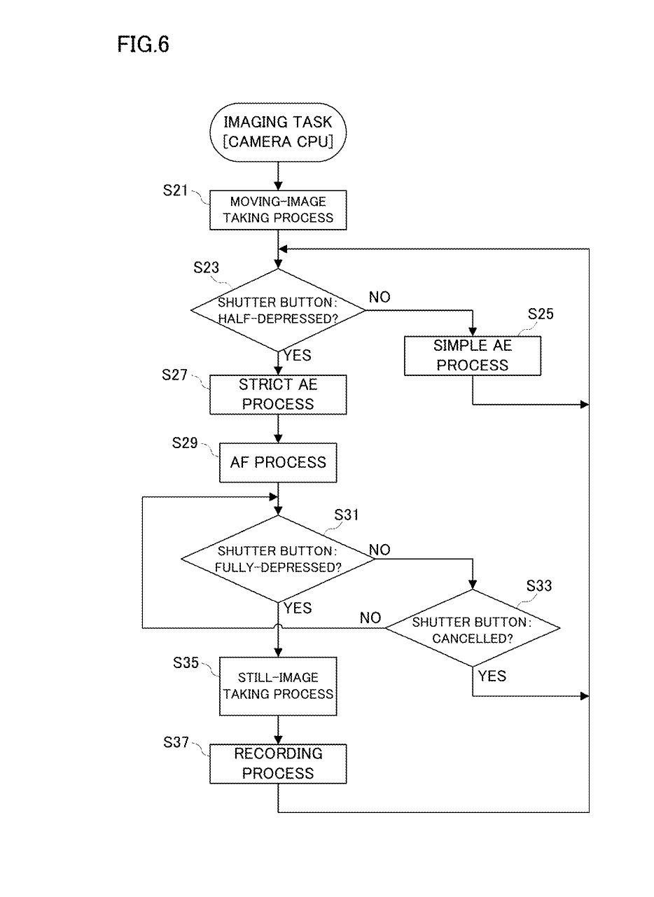

The imaging task executed in the digital camera 10 is configured as shown in FIG. 6. In a step S21, the moving-image taking process is executed. As a result, a live view image representing a scene captured on the imaging surface is displayed on the LCD monitor 30. In a step S23, it is determined whether or not the shutter button 36sh is half-depressed.

When a determined result of the step S23 is NO, in a step S25, the simple AE process is repeatedly executed. As a result, a brightness of the live view image is roughly adjusted. When the determined result of the step S23 is updated from NO to YES, in a step S27, the strict AE process is executed, and in a step S29, the AF process is executed. As a result of the strict AE process, the brightness of the live view image is strictly adjusted. Moreover, as a result of the AF process, a sharpness of the live view image is improved.

In a step S31, it is determined whether or not the shutter button 36sh is fully-depressed, and in a step S33, it is determined whether or not an operation of the shutter button 36sh is canceled. When a determined result of the step S33 is YES, the process directly returns to the step S23, whereas when a determined result of the step S31 is YES, the process returns to the step S23 via processes in steps S35 to S37.

In the step S35, the still-image taking process is executed. As a result, one frame of image data representing a scene at a time point at which the shutter button 36sh is fully-depressed is evacuated from the moving-image area 26a to the still image area 26b. In the step S37, the memory I/F 32 is commanded to execute the recording process. The memory I/F 32 reads out one frame of the image data stored in the still image area 26b through the memory control circuit 24 so as to record the read-out image data on the recording medium 34 in a file format.

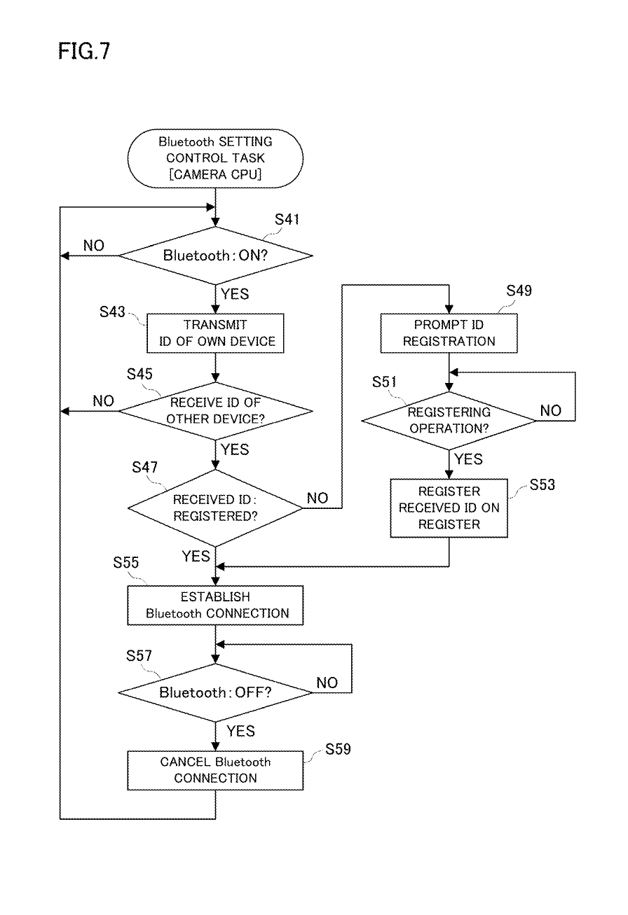

The Bluetooth setting control task executed in the digital camera 10 is configured as shown in FIG. 7. In a step S41, it is determined whether or not the Bluetooth communication function is in an on-state by an operation of the mode key 36md. When the determined result is updated from NO to YES, the process advances to a step S43 so as to command the RF module 46 to transmit an ID of own device. The RF module 46 transmits the ID of own device from the antenna 46at. In a step S45, it is determined whether or not the ID of an other device is received by the RF module 46, and when a determined result is NO, the process returns to the step S41, whereas when the determined result is YES, the process advances to a step S47.

In a step S47, it is determined whether or not the received ID of the other device is already registered in the registering means 50, and when a determined result is YES, the process directly advances to a step S55, whereas when the determined result is NO, the process advances to the step S55 via processes in steps S49 to S53.

In the step S49, the user is prompted to register the ID by using the LCD monitor 30, and in the step S51, it is repeatedly determined whether or not the registration operation by the registration button 36r is performed. When a determined result is updated from NO to YES, in the step S53, the received ID of the other device is registered in the registering means 50.

In the step S55, the Bluetooth connection is established, and in a step S57, it is repeatedly determined whether or not the Bluetooth communication function is turned off by the operation of the mode key 36md. When a determined result is updated from NO to YES, in a step S59, the Bluetooth connection is cancelled, and thereafter, the process returns to the step S41.

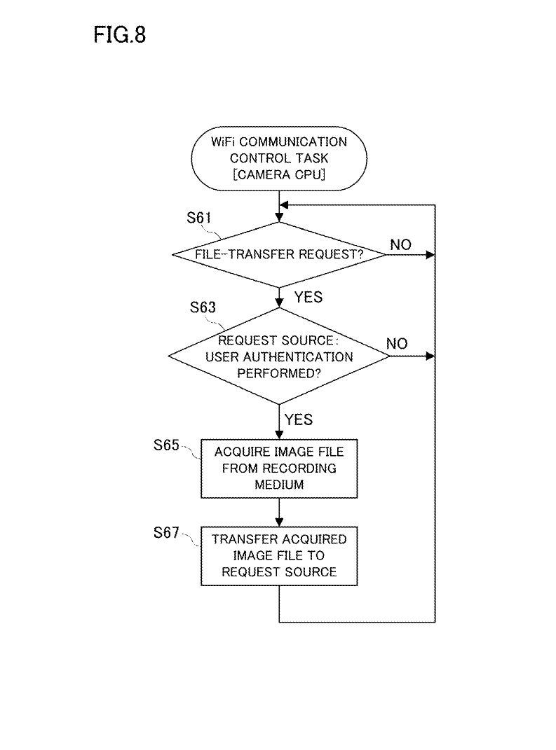

The WiFi communication control task executed in the digital camera 10 is configured as shown in FIG. 8. In a step S61, it is determined whether or not a file transfer request is received by the RF module 40, and in a step S63, it is determined whether or not a request source is a device of which the user authentication for the WiFi communication is completed. When any one of determined results of the step S61 and the step S63 is NO, the process returns to the step S61. In contrary, when both of the determined results of the step S61 and the step S63 is YES, an image file stored in the recording medium 34 is acquired in a step S65. The acquired image file is stored in the work area 26c of the SDRAM 26. In a step S67, the RF module 40 is commanded to transfer the acquired image file to the request source. The RF module 40 reads out the desired image file from the work area 26c through the SDIO 38 and the memory control circuit 24, so as to transmit the read-out image file to an issue source of the file transfer request through the antenna 40at.

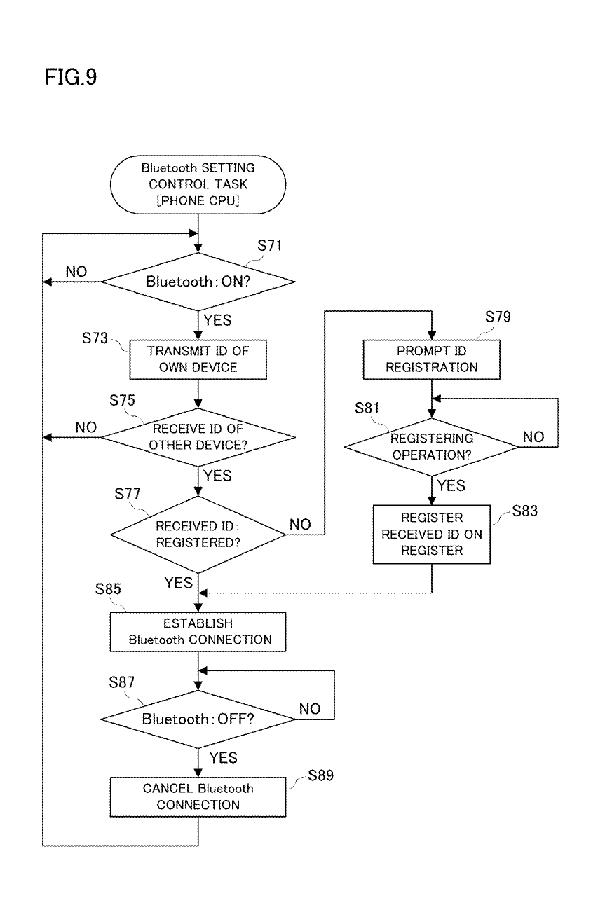

The Bluetooth setting control task executed in the smartphone 60 is configured as shown in FIG. 9. In a step S71, it is determined whether or not the Bluetooth communication function is in the on-state. When a determined result is updated from NO to YES, the process advances to a step S73 so as to command the RF module 84 to transmit the ID of own device. The RF module 84 transmits the ID of own device from the antenna 84at. In a step S75, it is determined whether or not the ID of an other device is received by the RF module 84, and when a determined result is NO, the process returns to the step S71, whereas when the determined result is YES, the process advances to a step S77.

In the step S77, it is determined whether or not the received ID of the other device is already registered in the registering means 88, and when a determined result is YES, the process directly advances to a step S85, whereas when the determined result is NO, the process advances to the step S85 via steps in S79 to S83.

In the step S79, the user is prompted to register the ID by using the LCD monitor 76, and in the step S81, it is repeatedly determined whether or not the registration operation by a touch is performed. When a determined result is updated from NO to YES, in the step S83, the received ID of the other device is registered in the registering means 88. In the step S85, the Bluetooth connection is established, and in a step S87, it is repeatedly determined whether or not the Bluetooth communication function is turned off. When a determined result is updated from NO to YES, in a step S89, the Bluetooth connection is cancelled, and thereafter, the process returns to the step S71.

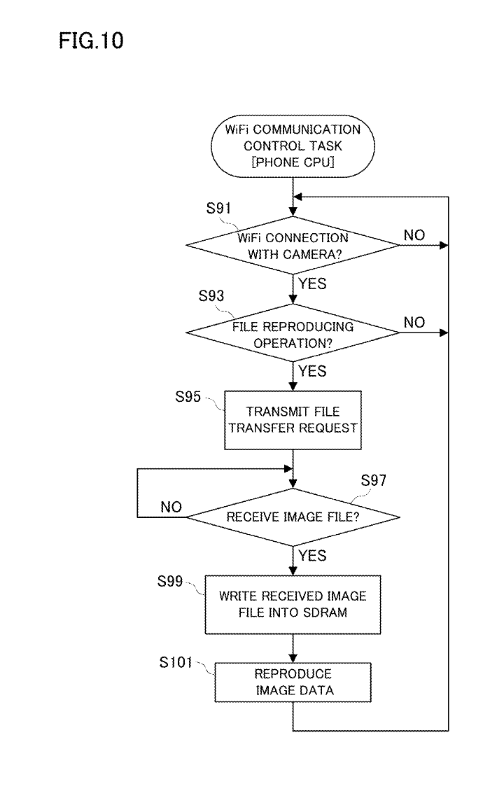

The WiFi communication control task executed in the smartphone 60 is configured as shown in FIG. 10. In a step S91, it is determined whether or not the WiFi connection with the digital camera 10 is established, and in a step S93, it is determined, based on the output of the touch sensor 78, whether or not the file-reproducing operation by the touch on the monitor screen is performed. When both of determined results of the step S91 and the step S93 are NO, the process returns to the step S91. In contrary, when both of the determined results of the step S91 and the step S93 are YES, the RF module 86 is commanded to issue the file transfer request The file transfer request is transmitted to the digital camera 10 through the antenna 86at.

In a step S97, it is determined whether or not the image file sent back from the digital camera 10 is received by the RF module 86. When a determined result is updated from NO to YES, in a step S99, the received image file is written into the SDRAM 72. In a step S101, the LCD driver 74 is commanded to reproduce image data. The LCD driver 74 reads out the image data of the received image file through the memory control circuit 70, so as to drive the LCD monitor 76 based on the read-out image data. As a result, an image photographed by the digital camera 10 is displayed on the monitor screen. Upon completion of the step S101, the process returns to the step S91.

As can be seen from the above-described explanation, the CPU46p arranged in the RF module 46 detects the ID of an other device transmitted by the Bluetooth communication, in the state where the main-power-source switch SW48 is turned off (S3), and turns on the main-power switch 48 when the detected ID of the other device is already registered in the registering means 50 (S7). The camera CPU 22 activated thereby detects the file transfer request transmitted by the WiFi communication (S61), and transfers the image file stored in the recording medium (34) to the request source in response to the detected file transfer request (S65 to S67).

Thus, when the registered ID of the other device transmitted by the Bluetooth communication is detected, the main-power switch 48 is changed from the off-state to the on-state. The image file stored in the recording medium 34 is transferred to the request source, in response to the file transfer request transmitted by the WiFi communication in this state. Thereby, the convenience is improved such that a battery life is extended, for example.

It is noted that, in this embodiment, the Bluetooth standard and the WiFi standard are assumed as two near field communication standards prepared in each of the digital camera 10 and the smartphone 6, however, as long as the two near field communication standards are respectively corresponding to two standards out of the WiFi standard, the Bluetooth standard, the NFC standard, the ZigBee standard, the RFID standard and the WirelessHD standard, the two standards to be prepared are not limited to the Bluetooth standard and the WiFi standard.

Moreover, in this embodiment, it is assumed that the image file is acquired from the digital camera, however, it will be obvious that the present invention may be applied to a case where an electronic file other than the image file is acquired from an electronic device other than the digital camera.

Furthermore, in this embodiment, the control programs equivalent to a plurality of tasks executed the camera CPU 22 of the digital camera 10 are previously stored in the flash memory 52.

However, a part of the control programs may be initially prepared in the flash memory 52 as an internal control program, whereas another part of the control programs may be acquired from an external server as an external control program. In this case, the above-described procedures are realized in cooperation with the internal control program and the external control program.

Moreover, in this embodiment, the processes executed by the camera CPU 22 are divided into a plurality of tasks in a manner described above. However, each of tasks may be further divided into a plurality of small tasks, and furthermore, a part of the divided plurality of small tasks may be integrated into another task Moreover, when each of tasks is divided into the plurality of small tasks, the whole task or a part of the task may be acquired from the external server.

Although the present invention has been described and illustrated in detail, it is clearly understood that the same is by way of illustration and example only and is not to be taken by way of limitation, the spirit and scope of the present invention being limited only by the terms of the appended claims.

### REFERENCE SIGNS LIST

10 digital camera

16 image sensor

22 camera CPU

40, 46, 62, 84, 86 RF module

30, 76 LCD monitor

48 main-power switch

68 smartphone CPU

1. An electronic file processing apparatus, comprising:
a first detecting means which detects, in a main-power-source off state, identification information transmitted by a first communication system;
an activating means which turns on a main power source when a predetermined condition on the identification information detected by said first detecting means is satisfied;
a second detecting means which detects, in a main-power-source on state, a file transfer request transmitted by a second communication system; and
a transferring means which transfers an electronic file stored in a recording medium to a request source in response to the file transfer request detected by said second detecting means.

2. An electronic file processing apparatus according to claim 1, further comprising a registering means which registers desired identification information in said main-power-source on state, wherein
said predetermined condition includes a condition under which the identification information detected by said first detecting means is equivalent to the identification information registered by said registering means.

3. An electronic file processing apparatus according to claim 1, wherein each of said first detecting means and said activating means executes a process under a back-up power source.

4. An electronic file processing apparatus according to claim 1, further comprising an imaging means which outputs image data corresponding to an optical image captured on an imaging surface, wherein
said electronic file is equivalent to a file containing the image data outputted from said imaging means.

5. An electronic file processing apparatus according to claim 1, wherein said first communication system and said second communication system respectively corresponds to two standards out of a WiFi standard, a Bluetooth standard, an NFC standard, a ZigBee standard, an RFID standard and a WirelessHD standard.

6. A file transfer program recorded on a non-transitory recording medium in order to control an electronic file processing apparatus, the program causing a processor of the electronic file processing apparatus to perform the steps comprises:
a first detecting step of detecting, in a main-power-source off state, identification information transmitted by a first communication system;
an activating step of turning on a main power source when a predetermined condition on the identification information detected by said first detecting step is satisfied;
a second detecting step of detecting, in a main-power-source on state, a file transfer request transmitted by a second communication system; and
a transferring step of transferring an electronic file stored in a recording medium to a request source in response to the file transfer request detected by said second detecting step.

7. A file transfer control method executed by an electronic file processing apparatus, comprising:
a first detecting step of detecting, in a main-power-source off state, identification information transmitted by a first communication system;
an activating step of turning on a main power source when a predetermined condition on the identification information detected by said first detecting step is satisfied;
a second detecting step of detecting, in a main-power-source on state, a file transfer request transmitted by a second communication system; and
a transferring step of transferring an electronic file stored in a recording medium to a request source in response to the file transfer request detected by said second detecting step.
